(19) United States
(12) Patent Application Publication
(10) Pub. No.: US 2003/0014660 A1
(43) Pub. Date: Jan. 16, 2003

(54) PC card security system

(76) Inventors: Christopher Verplaetse, Somerville, MA (US); W. David Lee, West Newton, MA (US); Thomas P. Evans, Watertown, MA (US); C. Gail Greenwald, Winchester, MA (US); Richard Kelly, Pleasanton, CA (US)

Correspondence Address: Iandiorio & Teska, 260 Bear Hill Road, Waltham, MA, 02451-1018, US

(21) Appl. No.: 10/128,384

(22) Filed: Apr. 23, 2002

Related U.S. Application Data
(60) Provisional application No. 60/286,859, filed on Apr. 26, 2001.

(51) Int. Cl. H04L 9/00

(52) U.S. Cl. 713/200

(57) ABSTRACT

A security system including a removable circuit card having an unauthorized movement detection subsystem including a motion sensor, a processor responsive to the motion sensor for detecting whether motion sensed thereby is indicative of unauthorized movement and a response circuit activated by the processor in response to unauthorized movement. The security system also includes a power source integrated with the circuit card for powering the unauthorized movement detection subsystem in the event of a lack of available external power including removal of the circuit card.

### RELATED APPLICATIONS

This application claims priority of U.S. utility application Ser. No. 09/572,801 filed May 17, 2000, and Ser. No. 09/773,165 filed Jan. 31, 2001; and Provisional Application No. 60/286,859 filed Apr. 26, 2001. All of these applications are included herein by this reference.

### FIELD OF THE INVENTION

This invention relates to a security system, typically embodied in a PC card, which prevents the theft of, inter alia, laptop computers.

### BACKGROUND OF THE INVENTION

Computers have conveniently become smaller. There are now notebook computers, hand held personal computers, and personal data assistants in addition to laptop computers.

However, because of their smaller size, computers are now easier to steal, for example, when left unattended for even a brief moment at an airport or in an office.

In U.S. Pat. No. 5,574,786, incorporated herein by this reference, a motion detector is coupled to a computer and the computer is disabled when it is moved. The primary problem with this device is that the computer is disabled whenever it is moved at all. Therefore, if the owner of the computer enables the motion detector and then accidentally moves the computer, the computer will be disabled. Another problem with the device of the '786 patent is that it is an integral component of the computer and thus cannot easily be integrated with existing computers nor can it be used in combination with other objects of value, for example, cellular telephones, other electronic devices, or works of fine art.

U.S. Pat. No. 5,675,321, also incorporated herein in its entirety by this reference, discloses a personal computer security apparatus which detects when the telephone line connected to the computer is disconnected. Although the '321 patent states that the apparatus may be housed on a circuit board within the personal computer and may activate the audible alarm of the personal computer, there is no disclosure teaching one skilled in the art how this engineering is accomplished. Moreover, the battery for the circuitry of the circuit board is located off the circuit board. Such a design, in conjunction with the use of the computer's audible alarm, renders the apparatus easy to defeat: the circuit board can be removed from the computer and, without power and without its own alarm, there is no way to stop a theft of the computer. Moreover, the apparatus of the '321 patent is not convenient to install and use and clearly is not a stand-alone independent, securely integrated system.

Other computer security systems are disclosed in U.S. Pat. Nos. 5,757,271; 5,748,083; 5,729,734; 5,821,933; 6,102,284; 6,144,314 and 6,282,655. These systems also suffer from one or more problems associated with the prior art discussed above.

### SUMMARY OF INVENTION

It is therefore an object of this invention to provide a more versatile, stand-alone, integral, and independent security system.

It is a further object of this invention to provide such a security system for objects of value including laptop computers, but also for works of fine art, cellular telephones and other electronic devices, and even dangerous items such as explosives and nuclear waste.

It is a further object of this invention to provide such a security system which is self-contained and can be easily incorporated and used in conjunction with a laptop computer.

It is a further object of this invention to provide such a security system which sounds an alarm even if the security system itself is removed from the laptop computer.

It is a further object of this invention to provide such a security system which filters out any movement of the object which does not constitute a theft of the object thus eliminating false alarms.

It is a further object of this invention to provide such a security system which can be enabled and disabled simply by moving the computer according to a predetermined set of orientations.

This invention results from the realization that theft of a laptop computer or other computer can be deterred and protected against by the inclusion of a security system on a removable PC card having its own accelerometer for sensing movement, processor for analyzing the sensed movement, audible alarm, and battery so that if either the computer is moved in an unauthorized way or if the PC card is removed, the alarms sounds. Such a PC card is not dependent on the sound card of the computer or the computer's battery as a power source. Moreover, such a “PC card”, because it is more fully integrated and operationally independent of the operation of the computer, can also be used in conjunction with other valuable or dangerous articles.

This invention features a security system comprising a removable circuit card comprising an unauthorized movement detection subsystem including a motion sensor, a processor responsive to the motion sensor for detecting whether motion sensed thereby is indicative of unauthorized movement and a response circuit activated by the processor in response to unauthorized movement. The security system also includes a power source integrated with the circuit card for powering the unauthorized movement detection subsystem in the event of a lack of available external power including removal of the circuit card.

In one embodiment, the motion sensor is an accelerometer, such as a multi-axis MEMS accelerometer with digital output or analog output received by the processor. Ideally, the processor is a microcontroller. The response circuit typically includes an audible alarm. In one example, the response circuit is configured to provide operating system blocking of boot process, BIOS level blocking of boot process and key management. Ideally, the power source is a rechargeable battery located within the PC card and the circuit card is type II PC card. Typically, the PC card includes a circuit board therein with the motion sensor and the processor mounted thereon.

In one example of this invention, the unauthorized movement detection subsystem further includes a power management circuit interconnected between the power source and the motion sensor for periodically powering down the motion sensor to save power. The processor may be programmed to activate the power management circuit periodically to supply power to the motion sensor and to detect an unauthorized movement, and, in the absence of unauthorized movement, to power down the motion sensor. Preferably, the alarm circuit includes a piezoelectric transducer and a drive circuit for amplifying the signal output by the processor to the piezoelectric transducer. In one embodiment, the unauthorized movement detection subsystem further includes a memory including encryption keys and the processor may be programmed to render the memory non-accessible in response to unauthorized movement. Ideally, the processor is a microcontroller and the microcontroller includes the memory. The memory may further include a unique identifier for preventing the circuit card from being used in an unauthorized manner and/or for preventing other circuit cards from being used in place of the circuit card.

In one design of this invention the unauthorized movement detection subsystem further includes a removal detection circuit and the processor is programmed to be responsive to the removal detection circuit and to activate the alarm circuit in response to removal of the circuit card. Typically, the processor is programmed to power down the power supply when the circuit card is removed to save power.

This invention also features a security system comprising a motion sensor, a processor responsive to the motion sensor for detecting whether motion sensed thereby is indicative of unauthorized movement, a response circuit activated by the processor in response to unauthorized movement, a power source for powering the system in the event of a lack of available external power, and a power management circuit interconnected between the power source and the motion sensor for periodically powering down the motion sensor to save power. The security system may also include a memory including encryption keys, the processor programmed to render the memory non-accessible in response to unauthorized movement. Ideally, the memory includes a unique identifier for preventing the system from being used in an unauthorized manner and/or for preventing other circuit cards from being used in place of the circuit card. In one preferred example, the security system may include a removal detection circuit, the processor programmed to be responsive to the removal detection circuit and to activate the response circuit in response to removal of the system.

This invention also features a removable PC card including a motion sensor, a processor responsive to the motion sensor for detecting whether motion sensed thereby is indicative of unauthorized movement, an audible alarm activated by the processor in response to unauthorized movement, a battery for providing power in the event of a lack of available external power including removal of the PC card, a power management circuit interconnected between the battery and the motion sensor for periodically powering down the motion sensor to save power and a memory including encryption keys. Preferably the processor is programmed to render the memory non-accessible in response to unauthorized movement. The PC card also includes a unique identifier stored in the memory for preventing the PC card from being used in an authorized manner and/or for preventing other circuit cards from being used in place of the circuit card, and a removal detection circuit and wherein the processor is programmed to be responsive to the removal detection circuit and to activate the audible alarm in response to removal of the PC card.

In other designs, the PC card of this invention preferably includes a circuit board having an accelerometer chip for sensing motion, a processor responsive to the accelerometer chip for detecting whether motion sensed thereby is indicative of unauthorized movement, a response circuit activated by the processor in response to unauthorized movement, a rechargeable battery for powering the components of the circuit board in the event of a lack of available external power including removal of the PC card, and an audible alarm activated by the response circuit in response to unauthorized movement. Ideally, the PC card is a type II PC card and the rechargeable battery is located within the PC card. The PC card may include a circuit board therein with the accelerometer and the processor mounted thereon. In one example, the PC card includes a memory with encryption keys stored therein and the processor is programmed to render the memory non-accessible in response to unauthorized movement. The memory may further include the unique identifier for preventing the PC card from being used in an unauthorized manner and/or for preventing other circuit cards from being used in place of the circuit card. In one embodiment, the PC card may further include a removal detection circuit and wherein the processor is programmed to be responsive to the removal detection circuit and to activate the audible alarm in response to removal of the PC card.

This invention also features a security system comprising a removable circuit card including an unauthorized movement detection subsystem including means for sensing motion, a processor responsive to the means for sensing motion for detecting whether motion sensed thereby is indicative of unauthorized movement, alarm means activated by the processor in response to unauthorized movement. The security system also includes power means integrated with the circuit card for powering the unauthorized movement detection subsystem in the event of a lack of available external power including removal of the circuit card. Typically, the means for sensing motion is an accelerometer. Preferably, the alarm means includes an audible alarm, and the power means is a rechargeable battery.

### BRIEF DESCRIPTION OF THE DRAWINGS

Other objects, features and advantages will occur to those skilled in the art from the following description of a preferred embodiment and the accompanying drawings in which:

FIG. 1 is a schematic view of an embodiment of the security system of the subject invention;

FIG. 2 is a schematic view of a laptop computer including the embodiment of the security system of this invention shown in FIG. 1;

FIG. 3 is a block diagram showing the primary components associated with the embodiment of the security system shown in FIG. 1;

FIG. 4 is another schematic view showing the layout of the primary components associated with the security system shown in FIG. 1;

FIG. 5 is a circuit diagram showing, in more detail, the primary circuitry associated with the security system of this invention;

FIG. 6 is a flow circuit depicting the primary steps associated with the routine which locks the encryption keys in the case of unauthorized movement in accordance with this invention; and

FIG. 7 is a flow chart depicting the primary steps associated with the routine which stores and evaluates the unique identifier of the security system of this invention.

### DESCRIPTION OF PREFERRED EMBODIMENT

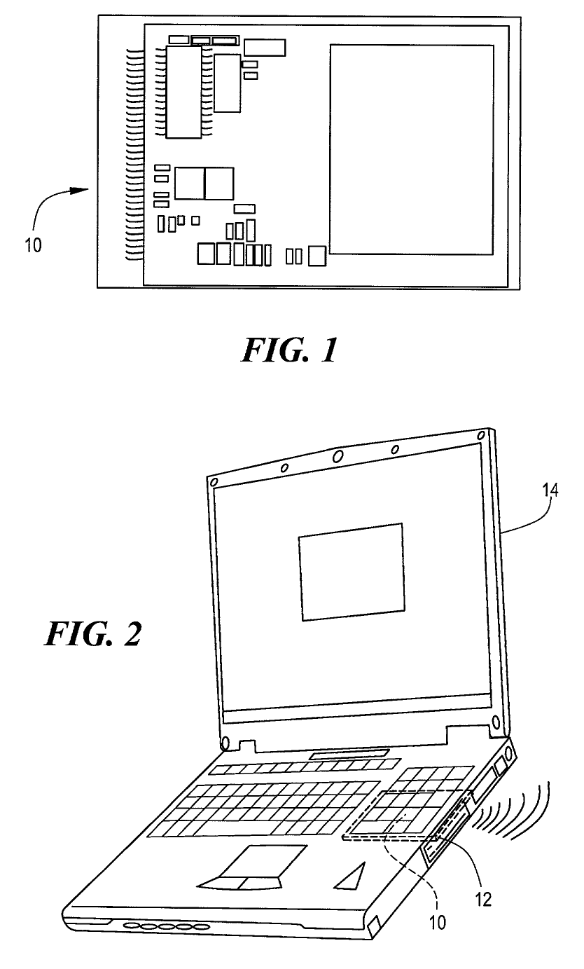

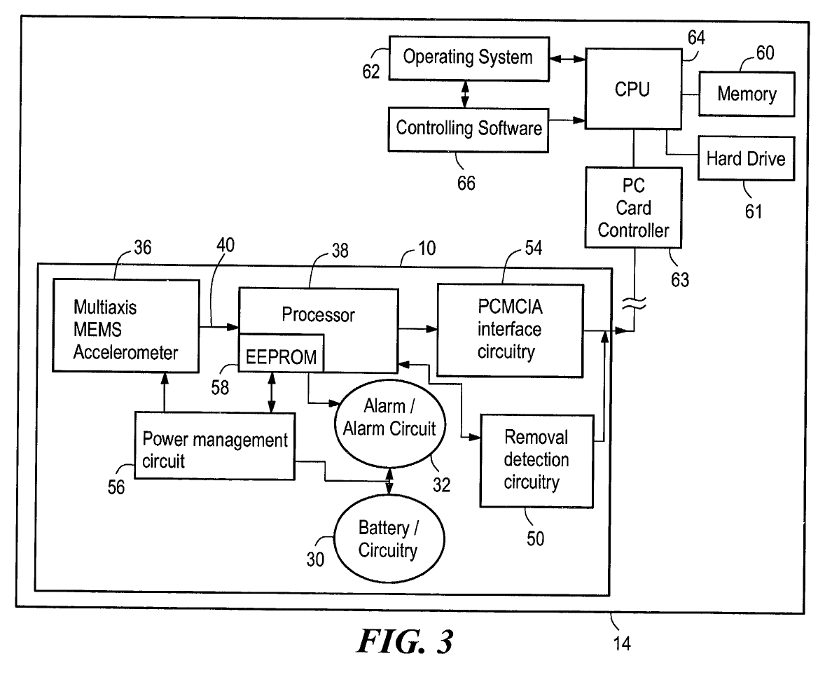

The security system of this invention is typically embodied in removable type II PC card 10, FIG. 1 received in the PCMCIA slot 12 of laptop computer 14 as shown in FIG. 2. When computer 14 is moved in an unauthorized way or when PC card 10 is removed from slot 12 of computer 14, an audible alarm sounds and continues to sound because PC card 10, FIG. 3 includes its own power source means typically in the form of rechargeable coin cell battery and its associated circuitry 30 and also alarm/alarm circuitry 32.

The theft detection subsystem of the PC card preferably includes a motion sensor or sensing means such as multi-axis MEMS accelerometer 36 (for example part no. ADXL 202 available from Analog Devices, Inc., Wilmington, Mass.) which senses motion of PC card 10 and computer 14. Processor 38 (for example a microcontroller with its own memory, e.g., EEPROM 58) is responsive to accelerometer 36 schematically shown by line 40 and programmed to detect whether motion sensed by accelerometer 36 is truly indicative of unauthorized motion such as a theft event or, instead, is motion associated with the normal movement of computer 14 as it is used by the authorized user. In one embodiment, the movement algorithms discussed in co-pending application Ser. No. 09/572,801 are utilized. In other embodiments, however, processor 38 is programmed to analyze the signals of accelerometer 36 on the basis of the amount of movement within specified time periods and, typically, these limits can even be customized by the user.

A response circuit, typically alarm means, such as alarm/alarm circuit 32 is activated by processor 38 in response to the detection of a theft event. In the preferred embodiment, the alarm/alarm circuit includes a piezoelectric transducer and a drive circuit for amplifying the signal output by the processor to the transducer. In addition, or alternatively, the alarm means includes software and/or circuitry which locks the hard drive of computer 14, FIG. 1 or the like to deny access to the files of computer 14 or to render its operating system non-usable.

One theft event is unauthorized movement of computer 14. In this case, processor 38, in the preferred embodiment, activates alarm/alarm circuit 32 to issue a series of single beeps and, if the unauthorized movement does not stop, a series of double beeps, and then a series of triple beeps all at 85 dB at 10 cm. If movement stops, the beeps stop. If movement does not stop, however, the theft state is entered and a series of 110 dB beeps is sounded. The only way to stop these louder beeps is to enter a password into computer 14, either by typing or by the entry of a “motion password” as disclosed in co-pending application Ser. No. 09/773,165 filed Jan. 31, 2001.

If the theft event is removal of PC card 10 from computer 14 as detected by removal detection circuit 50, FIG. 3 processor 38 is programmed to activate alarm/alarm circuit 32 to sound warning beeps at 85 dB for twenty seconds and then a continuous 110 dB beep. Re-insertion of PC card 10 stops the warning beeps. Other theft events detected by processor 38 include unsuccessful attempts to enter a password. Note that the alarm circuit activated by the processor and responsive to a theft event in accordance with this invention is not limited to an audible alarm. Other theft event alarm actions include locking access to the data in memory 60 and hard drive 61 of computer 14 and/or blocking access to operating system 62 (e.g., Microsoft™ Windows XP) thereof. Preferably, these actions are taken in conjunction with an audible alarm and thus, in the subject invention, EEPROM 58 stores encryption keys for any encrypted data or files on computer 14 and also a unique identifier for PC card 10. Processor 38 of PC card 10 then interfaces via PCMCIA interface circuit 54 and PC card controller 63 with CPU 64 of computer 14 which itself utilizes operating system 62, memory 60, and controlling software 66 available from the assignee hereof as the CAVEO™ brand Anti-Thef™ PC card laptop computer security system. In the event of an unauthorized motion, such as a theft event processor 38 and controlling software 66 prohibit use of operating system 62 on computer 14 by blocking the boot process prior to user log in, and requiring entry of an “emergency password”. Processor 38 is also configured to perform key management which renders encrypted data stored on hard drive 61 non-accessible because the encryption keys stored in EEPROM 58 cannot be used to access encrypted files whether via computer 14 or another computer. Moreover, a unique identifier for PC card 10 is stored in memory 60 and/or hard drive 61, and therefore a thief cannot remove card 10 and replace it with another card with a different identifier in an attempt to defeat the security system. Process 38 is also configured to provide blocking of the boot process and BIOS level blocking.

Another feature of the theft detection subsystem of this invention is power management circuit 56 which extends the life of battery 30 from about five hours to three to four weeks or longer. Again, battery 30 powers the theft detection system when computer power is not available, for example when the computer 14 is turned off and also when PC card 10 is removed from computer 14. Power management circuit 56 is interconnected between battery 30 and accelerometer 36 and is designed to periodically power down accelerometer 36 to save power. Preferably, processor 38 is programmed to activate power management circuit 56 to periodically supply power to accelerometer 36 and to processor 38. Processor 38 then analyzes whether any motion is occurring and, in the absence of a motion, powers down accelerometer 36 via power management circuit 56. If motion is detected, processor 38 will stay powered and will keep accelerator 36 powered and processor 38 will screen for theft-type motion until no motion is sensed or until a theft event occures.

this way, when the security system of this invention is activated by a switch, the entry of a password, or a “motion password”, theft of the laptop computer is prevented by the inclusion of a complete security system on a removable PC card having its own accelerometer for sensing movement, processor for analyzing the sensed movement, audible alarm, and battery so that either if the computer is moved in an unauthorized way or if the PC card is removed, the alarm sounds and encrypted files are rendered inaccessible. PC card 14, FIGS. 1-4 is not dependent on the sound card of computer 14 or its battery or other power source. Moreover, PC card 10, because it is more fully integrated and operational independent of the operation of computer 14, can also be used in conjunction with other valuable or dangerous articles by simply attaching it to a work of fine art, or a container filled with explosives or dangerous chemicals.

In the preferred embodiment discussed thus far, the PC card power source in the form of battery 30 and its associated circuitry as shown in FIG. 3 is integrated with PC card 10 by physically encapsulating it within the body of the type II PC card as shown in FIG. 1. This is not a necessary limitation of the subject invention, however, as the power source can be integrated with the other components of the theft detection subsystem located on a different type of circuit card and also in other ways as understood by those skilled in the art.

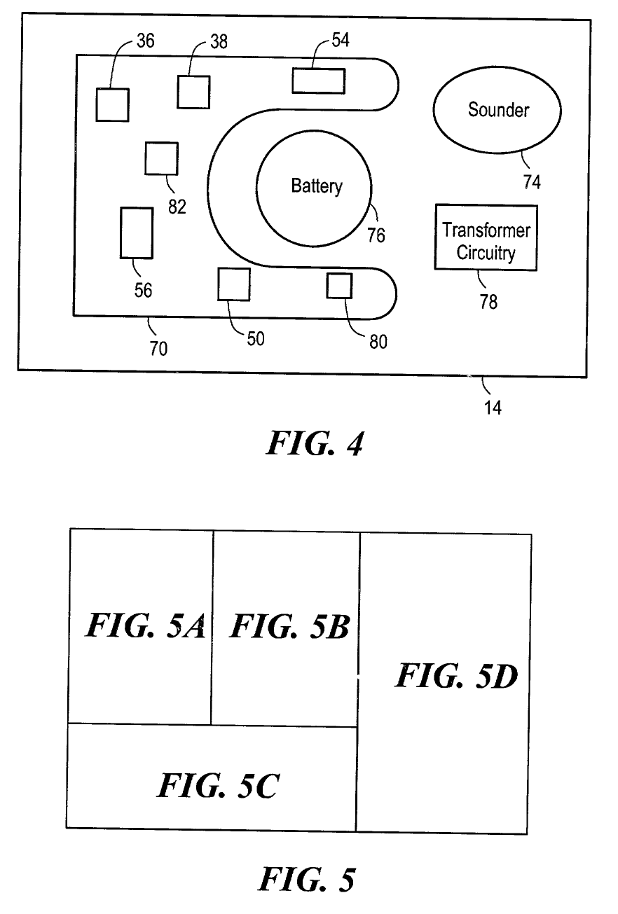

In the preferred embodiment, PC card 10, FIG. 4 includes circuit board 70 with accelerometer chip 36, microcontroller 38, PCMCIA interface circuit 54, power management circuit 56 and removable detection circuit 50 mounted thereon. Piezoelectric sounder 74, battery 76, and transformer 78 are located off circuit board 70. Battery circuit 80 and the portion of alarm drive circuit 82 are apart from transformer 78, however, are located on circuit board 70. All of these circuits will now be discussed in more detail.

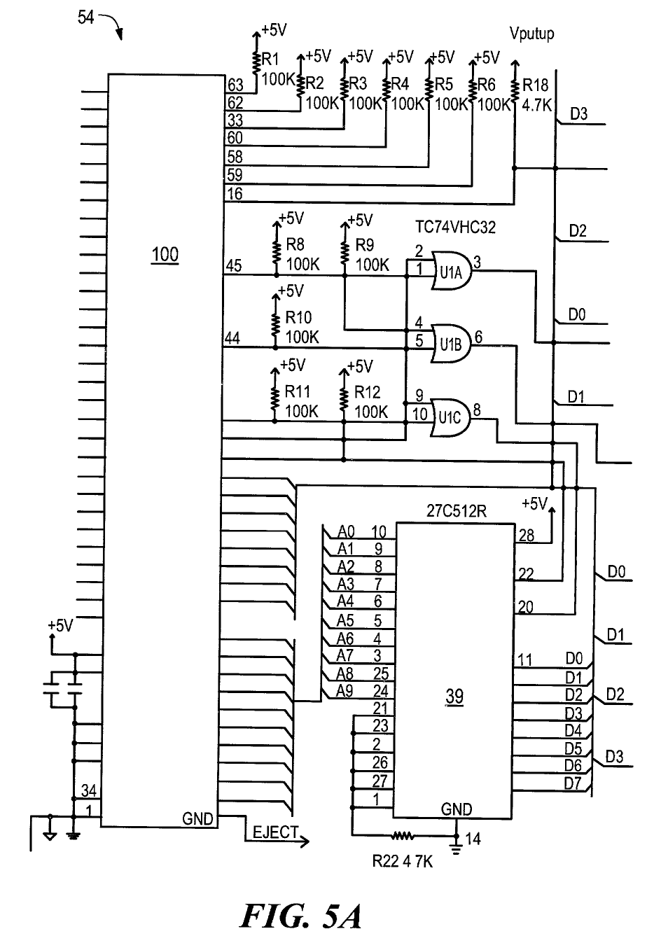

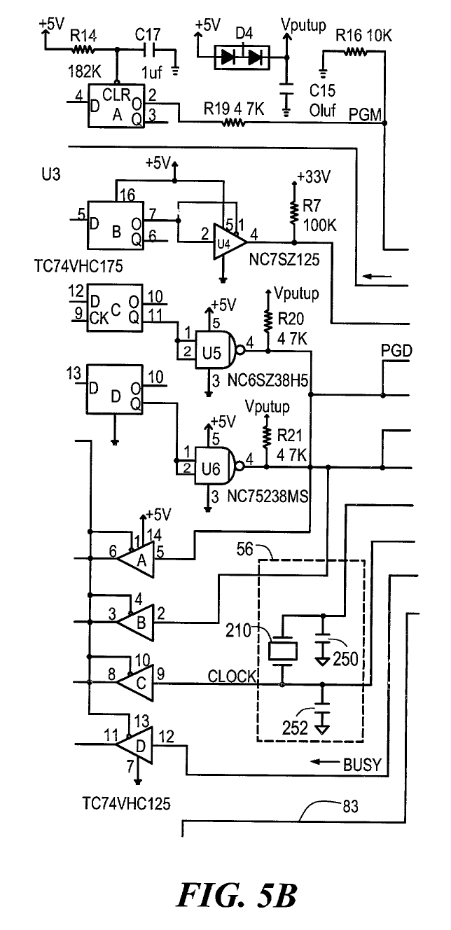

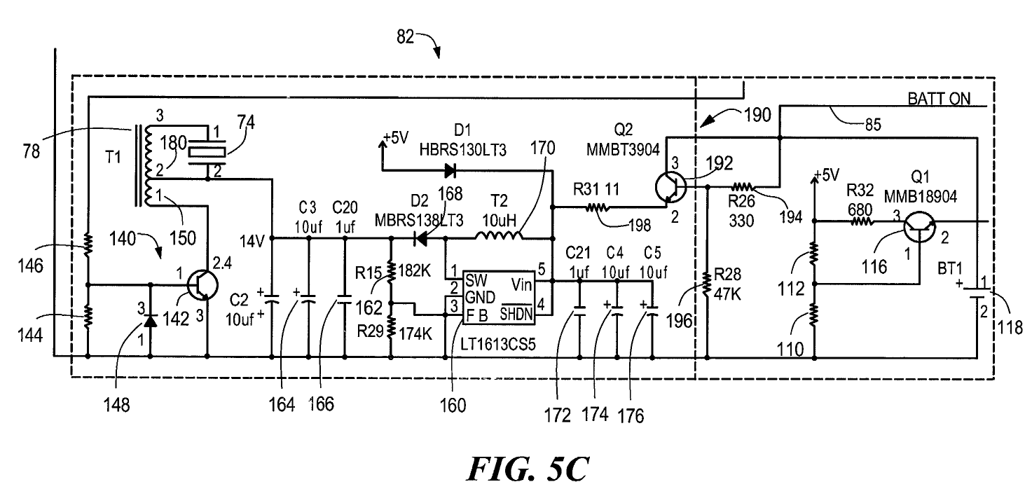

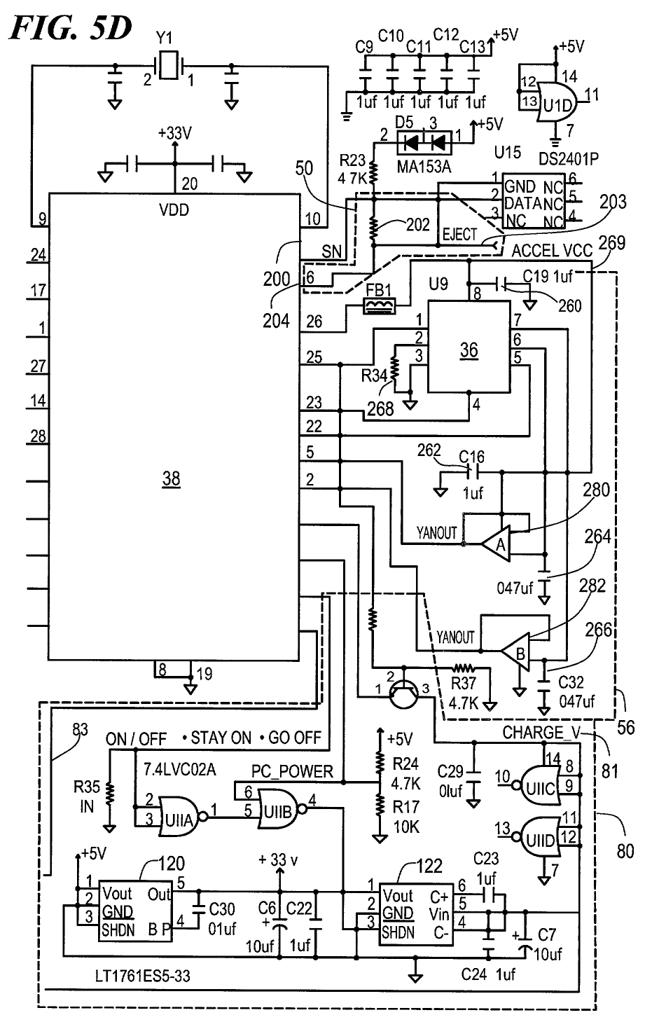

FIG. 5 shows PCMCIA interface 54 including PCMCIA bus 100 and CIS PROM 39, processor 38 in the form of a microcontroller, accelerometer 36, power management circuit 82, alarm 74, removal detection circuit 50, and battery circuit 80.

In battery circuit 80, when +5V is present, it is passed through the voltage divider including resistors 110 and 112 and through NPN transistor 116 to trickle charge battery 118. When +5V is present, it is regulated to +3.3V using voltage regulator 120 to supply power to the theft detection circuit. When +5V is not present, the battery voltage is passed through charge pump 122 to generate the +3.3V supply power for the theft detection circuit. The battery voltage level on line 81 is an input to the A/D port of microcontroller 38 so the software operating on controller 38 can monitor the battery level. Microcontroller 38 may optionally shut down charge pump 122 completely shutting down the entire card when it is removed from the laptop. In this way, battery power is saved when the card is stored in a warehouse, and the like.

In alarm circuit 82, and microcontroller 38 controls signal on line 83 which controls transistor circuit 140 including transistor 142, resistors 144 and 146, and diode 148. Transistor circuit 140 sets transformer 78, pin 150 either at ground or at a floating level. The AC voltage input signal (14V) to the primary coil of transformer 78 is transformed to approximately 91V and is fed to piezo transducer 74 which emits an audible tone. DC-to-DC converter 160 and its corresponding circuit including resistor 162, capacitors 164 and 166, diode 168, inductor 170, capacitors 172, 174 and 176 accepts either the +5V laptop power source if present, or the battery voltage, if the signal on line 85 is active, and converts it to 14V which is applied to transformer 78, pin 180. Microcontroller 38 is programmed to set the signal on line 85 which controls NPN transistor circuit 190 including transistor 192 and resistors 194, 196, and 198 to allow the battery voltage to power DC-to-DC converter circuit 160.

In removal detection circuit 50, microcontroller 38 may set signal on pin 200 which will pull up signal on line 203 through resistor 202 if the PC card is removed. Otherwise, if the PC card is inserted, the signal on line 203 will remain at ground. Microcontroller pin 200 is configured as an input pin to determine the value of the eject signal to determine if the card is removed from the laptop. Eject pin 204 is attached directly to pin 210 of the PCMCIA bus 100 which is connected to a ground signal within the laptop computer. If the PC card is inserted, this signal will be ground. If the PC card is removed, this signal will be floating.

Power management circuit 56 forces the theft detection system to go into a low-power mode when the system has been still for a predetermined duration. In the low power mode, all the chips are typically powered down. Microcontroller 38 uses an external watch crystal 210 (32.768 KHz) and its internal timer to wake it and the accelerometer 36 approximately once every 500 ms. Microcontroller 38 is programmed to determine if any motion has occurred, and if so, will invoke the full theft detection mode analysis.

The analog output signals of accelerometer 36 are buffered by a non-inverting amplifier with a gain equal to 1. This isolates the signal giving a high input impedance, low output impedance. These amplified signals are driven to the analog inputs of the A/D pin of microcontroller 38. The algorithm implemented thereon takes samples of accelerometer signals X and Y and compares them with the previous samples taken. If the absolute value of that difference is higher than a predefined threshold value, then it is assumed that motion has occurred. Crystal circuit 210 (32.768 KHz) with capacitors 250 and 252 is connected to the internal timer of microcontroller 38 which is used for waking up the microcontroller when it is sleeping. Accelerometer 36 and its supporting circuitry including capacitors 260, 262, 264 and resistor 268 is powered by a signal on line 269 from microcontroller 38. The accelerometer has two analog output signals which are fed to two op-amp buffers 280 and 282 used to buffer the accelerometer's analog outputs. The buffered outputs are fed to the microcontroller's A/D port.

This way, a power source, namely battery 118 and battery circuit 80 is integrated with accelerometer 36, processor 38, and alarm circuit 82 for powering the theft detection system in the event of unavailable PC power such as when the computer is turned off and also, when the computer is turned on, and when the PC card is removed from the computer. In summary, power management circuit 56 interconnected between battery circuit 80 and accelerometer 36 and controlled by processor 38 periodically powers down accelerometer 36 to save power.

Alarm circuit 82 amplifies the signal output by processor 38 to transducer 74. And, removal detection circuit 50 in combination with processor 38 actuates alarm circuit 82 if the PC card is removed from the laptop computer.

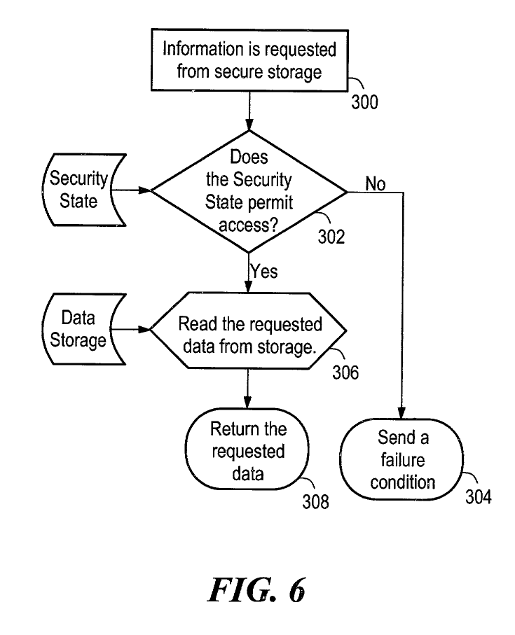

In addition, in the event of a theft event, processor 38, FIG. 5 is programmed as shown in FIG. 6 to render the encryption keys non-accessable. If, in step 300, encryption key information is requested by the user, processor 38 checks the security state, step 302. If the security state indicates an unauthorized movement such as a theft event has occurred, access is denied and a failure condition is reported, step 304. If a theft event has not occurred, processor 38 reads the encryption keys from storage, step 306 and returns the requested information.

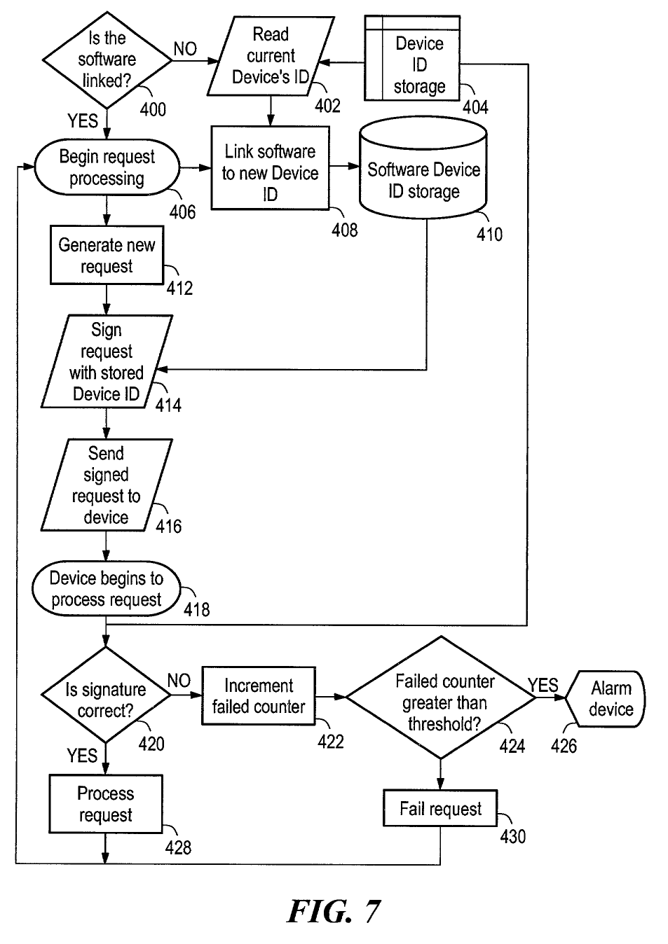

In accordance with this invention, prevention of theft or access using a non-sanctioned device, processor 38, FIG. 3 and a CPU 64 are programmed as shown in FIG. 7 to render operation of the device solely to a desired device/host bond. If in step 400, CPU 64 of computer 14 detects it is not bound to processor 38 of PC card 10, CPU 64 reads the present device ID, step 402 from the device's storage, step 404. CPU 64 then programs itself, step 408 to identify only with the device present by storing the device ID local to CPU 64. Processor 38 and CPU 64 are then ready to begin linked processing, step 406. If processor 64 is bound to a device ID, processors 38 and CPU 64 begin linked processing, step 406. CPU 64 processes a request to processor 38, step 412, and CPU 64 signs the request with the device ID stored, step 410. CPU 64 then transmits the signed request to processor 38, step 416, and begins to process the request in step 418. Processor 38 then uses its device ID stored in step 404 to verify the authenticity of the request in step 420. If processor 38 determines in step 420 that the request is valid for the device/host bond, it processes the request in step 428. If processor 38 determines in step 420 that the request is invalid for the device/host bond, it increments a failed attempt counter, step 422. If the failed request counter is greater than a predetermined threshold as determined in step 424, then the device assumes the theft state and alarms, step 426. If the failed request counter is less than or equal to the predetermined threshold as determined in step 424, processor 38 fails to process the request, step 430 and allows for request processing to be retried, step 406.

This way, the security of personal and corporate property, particularly expensive electronic goods, is improved. Computers, video cameras, CD ROMs, CD players, portable TVs, printers, and scanners are popular targets for theft in the home and business environment. The laptop, palmtop and notebook computers are the fastest growing stolen items in the US. As these computers become smaller and more sophisticated, they can be more easily moved and concealed. In this invention, movement and concealment of such devices is protected against.

The developing trend toward storing vast amounts of personal and business data and software on a computer hard drive makes theft and tamper deterrence all the more important. Therefore there is a need to protect an asset, such as a computer or associated peripheral, from being stolen or otherwise removed from its proper location, and to protect the stored data as well. Many present protection systems rely on either a physical restraint (cable) and/or a motion detector, which sets off an alarm. The motion detection is done with mechanical (mercury) switches which initiate an alarm when a certain preset level of motion is detected. The system is a separate unit. Other systems protect the data in the computer by requiring a password, or peripheral devices which contain a password in order to boot up or access the system.

Palmtop, laptop, or notebook computers are intended to be used at a variety of locations and it is advantageous to have a smart motion security system that permits authorized removal without a cumbersome, time-consuming password disarm procedure, but that can also inhibit unauthorized access to data.

This invention overcomes the drawbacks of present systems. It takes advantage of the dramatic advances in micromachined semiconductor products technology and employs a micromachined accelerometer integrated on a chip which is mounted upon or within the computer or in a PC card. The signal from the accelerometer is used (by microprocessor) to determine the nature of the motion (i.e. incidental shock or real displacement) and approximate distance moved. The firmware allows the user to program two forms of identification: a password or a learned (secure) combination of motions that the accelerometer and software have been taught. The motion password allows the user to arm or disarm the computer (or other asset) security system by physically moving the computer in a predefined manner than can be recognized by the motion analysis algorithms of the microcontroller.

Accelerometer 36, FIG. 4, provides input to microprocessor 38. A nonvolatile memory may store system configuration and security bits that represent the state of the device. Microcontroller 38 interfaces with both of these devices, and employs motion-analysis algorithms to process the output of accelerometer 36 and accordingly update the security bits. Firmware being executed on processor 38 contains the instruction set to translate the acceleration detected and determine whether one of the user-chosen movement/displacement conditions have been exceeded. It then sequences audible alarm circuit 82, FIG. 5 or alternatively transmits an interrupt signal via interface circuit 54 and PC card controller 63 to controlling software 66 which will control computer 14 to play an audible message and also lock out the use of computer 14, and even the data and operating system 62, FIG. 3 until the correct emergency password is given.

Although specific features of the invention are shown in some drawings and not in others, this is for convenience only as each feature may be combined with any or all of the other features in accordance with the invention. Moreover, other embodiments will occur to those skilled in the art and are within the following claims:

What is claimed is:

1. A security system comprising:
a removable circuit card including an unauthorized movement detection subsystem comprising:
a motion sensor;
a processor responsive to the motion sensor for detecting whether motion sensed thereby is indicative of unauthorized movement;
a response circuit activated by the processor in response to unauthorized movement; and
a power source integrated with the circuit card for powering the unauthorized movement detection subsystem in the event of a lack of available external power including removal of the circuit card.

2. The security system of claim 1 in which the motion sensor is an accelerometer.

3. The security system of claim 2 in which the accelerometer is a multi-axis MEMS accelerometer with digital output or analog output received by the processor.

4. The security system of claim 1 in which the processor is a microcontroller.

5. The security system of claim 1 in which the response circuit includes an audible alarm.

6. The security system of claim 1 in which the response circuit is configured to provide operating system blocking of boot process, BIOS level blocking of boot process and key management.

7. The security system of claim 1 in which the power source is a rechargeable battery.

8. The security system of claim 7 in which the circuit card is type II PC card and the rechargeable battery is located within the PC card.

9. The security system of claim 8 in which the PC card includes a circuit board therein with the motion sensor and the processor mounted thereon.

10. The security system of claim 1 in which the unauthorized movement detection subsystem further includes a power management circuit interconnected between the power source and the motion sensor for periodically powering down the motion sensor to save power.

11. The security system of claim 10 in which the processor is programmed to activate the power management circuit periodically to supply power to the motion sensor, to detect an unauthorized movement, and, in the absence of unauthorized movement, to power down the motion sensor.

12. The security system of claim 1 in which the alarm circuit includes a piezoelectric transducer and a drive circuit for amplifying the signal output by the processor to the piezoelectric transducer.

13. The security system of claim 1 in which the unauthorized movement detection subsystem further includes a memory including encryption keys and the processor is programmed to render the memory non-accessible in response to unauthorized movement.

14. The security system of claim 13 in which the processor is a microcontroller and the microcontroller includes the memory.

15. The security system of claim 13 in which the memory further includes a unique identifier for preventing the circuit card from being used in an unauthorized manner and/or for preventing other circuit cards from being used in place of the circuit card.

16. The security system of claim 1 in which the unauthorized movement detection subsystem further includes a removal detection circuit and the processor is programmed to be responsive to the removal detection circuit and to activate the alarm circuit in response to removal of the circuit card.

17. The security system of claim 1 in which the processor is programmed to power down the power supply when the circuit card is removed to save power.

18. A security system comprising:
a motion sensor;
a processor responsive to the motion sensor for detecting whether motion sensed thereby is indicative of unauthorized movement;
a response circuit activated by the processor in response to unauthorized movement;
a power source for powering the system in the event of a lack of available external power; and
a power management circuit interconnected between the power source and the motion sensor for periodically powering down the motion sensor to save power.

19. A security system comprising:
a motion sensor;
a processor responsive to the motion sensor for detecting whether motion sensed thereby is indicative of unauthorized movement;
a response circuit activated by the processor in response to unauthorized movement;
a power source for powering the system in the event of a lack of available external power; and
a memory including encryption keys, the processor programmed to render the memory non-accessible in response to unauthorized movement.

20. A security system comprising:
a motion sensor;
a processor responsive to the motion sensor for detecting whether motion sensed thereby is indicative of unauthorized movement;
a response circuit activated by the processor in response to unauthorized movement;
a power source powering the system in the event of a lack of available external power; and
a memory including a unique identifier for preventing the system from being used in an unauthorized manner and/or for preventing other circuit cards from being used in place of the circuit card.

21. A security system comprising:
a motion sensor;
a processor responsive to the motion sensor for detecting whether motion sensed thereby is indicative of unauthorized movement;
a response circuit activated by the processor in response to unauthorized movement;
a power source for powering the system in the event of a lack of available external power; and
a removal detection circuit, the processor programmed to be responsive to the removal detection circuit and to activate the response circuit in response to removal of the system.

22. A removable PC card including:
a motion sensor;
a processor responsive to the motion sensor for detecting whether motion sensed thereby is indicative of unauthorized movement;
an audible alarm activated by the processor in response to unauthorized movement;
a battery for providing power in the event of a lack of available external power including removal of the PC card;
a power management circuit interconnected between the battery and the motion sensor for periodically powering down the motion sensor to save power;
a memory including encryption keys and wherein the processor is programmed to render the memory non-accessible in response to unauthorized movement;
a unique identifier stored in the memory for preventing the PC card from being used in an authorized manner and/or for preventing other circuit cards from being used in place of the circuit card; and
a removal detection circuit and wherein the processor is programmed to be responsive to the removal detection circuit and to activate the audible alarm in response to removal of the PC card.

23. A PC card comprising:
a circuit board including:
an accelerometer chip for sensing motion;
a processor responsive to the accelerometer chip for detecting whether motion sensed thereby is indicative of unauthorized movement;
a response circuit activated by the processor in response to unauthorized movement;
a rechargeable battery for powering the components of the circuit board in the event of a lack of available external power including removal of the PC card; and
an audible alarm activated by the response circuit in response to unauthorized movement.

24. The PC card of claim 23 in which the PC card is a type II PC card and the rechargeable battery is located within the PC card.

25. The PC card of claim 23 in which the PC card includes a circuit board therein with the accelerometer and the processor mounted thereon.

26. The PC card of claim 23 in which the circuit board further includes a power management circuit interconnected between the power source and the accelerometer for periodically powering down the accelerometer to save power.

27. The PC card of claim 26 in which the processor is programmed to activate the power management circuit periodically to supply power to the accelerometer, to detect unauthorized movement, and, in the absence of unauthorized movement, to power down the accelerometer.

28. The PC card of claim 23 in which the response circuit includes a piezoelectric transducer and a drive circuit for amplifying a signal output by the processor to the piezoelectric transducer.

29. The PC card of claim 23 further including a memory with encryption keys stored therein, the processor programmed to render the memory non-accessible in response to unauthorized movement.

30. The PC card of claim 29 in which the processor is a microcontroller and the microcontroller includes the memory.

31. The PC card of claim 28 in which the memory further includes the unique identifier for preventing the PC card from being used in an unauthorized manner and/or for preventing other circuit cards from being used in place of the circuit card.

32. The PC card of claim 23 further including a removal detection circuit and wherein the processor is programmed to be responsive to the removal detection circuit and to activate the audible alarm in response to removal of the PC card.

33. A PC card comprising:
an accelerometer chip for sensing motion;
a processor responsive to the accelerometer chip for detecting whether motion sensed thereby is indicative of unauthorized movement;
an audible alarm activated by the processor in response to unauthorized movement;
a rechargeable battery for providing power in the event of a lack of available external power including removal of the PC card; and
a power management circuit interconnected between the rechargeable battery and the accelerometer for periodically powering down the accelerometer to save power.

34. A PC card comprising:
a motion sensor chip for sensing motion;
a processor responsive to the motion sensor chip for detecting whether motion sensed thereby is indicative of unauthorized movement;
an audible alarm activated by the processor in response to unauthorized movement;
a rechargeable battery for providing power in the event of a lack of available external power including removal of the PC card; and
a memory including encryption keys, and wherein the processor is programmed to render the memory non-accessible in response to unauthorized movement.

35. A PC card comprising:
a motion sensor chip for sensing motion;
a processor responsive to the motion sensor chip for detecting whether motion sensed thereby is indicative of unauthorized movement;
an audible alarm activated by the processor in response to unauthorized movement;
a rechargeable battery for providing power in the event of a lack of available external power including removal of the PC card; and
a memory including a unique identifier for preventing the PC card from being used in an unauthorized manner and/or for preventing other circuit cards from being used in place of the circuit card.

36. A PC card comprising:
a motion sensor chip for sensing motion;
a processor responsive to the motion sensor chip for detecting whether motion sensed thereby is indicative of unauthorized movement;
an audible alarm circuit activated by the processor in response to unauthorized movement;
a rechargeable battery for providing power in the event of a lack of available external power including removal of the PC card; and
a removal detection circuit and wherein the processor is programmed to be responsive to the removal detection circuit and to activate the audible alarm in response to removal of the PC card.

37. A PC card comprising:
a motion sensor;
a processor responsive to the motion sensor chip for detecting whether motion sensed thereby is indicative of unauthorized movement;
a response circuit activated by the processor in response to unauthorized movement;
a power source for providing power in the event of a lack of available external power including removal of the PC card;
a power management circuit interconnected between the power source and the motion sensor for periodically powering down the motion sensor to save power;
a memory including encryption keys, and wherein the processor is programmed to render the memory non-accessible in response to unauthorized movement, the memory further including a unique identifier for preventing the PC card from being used in an unauthorized manner and/or for preventing other circuit cards from being used in place of the circuit card; and
a removal detection circuit, the processor programmed to be responsive to the removal detection circuit and to activate the response circuit in response to the removal of the PC card.

38. The PC card of claim 37 in which the motion sensor is an accelerometer.

39. The PC card of claim 38 in which the accelerometer is a multi-axis MEMS accelerometer with digital output or analogy output received by the processor.

40. A security system comprising:
a removable circuit card including an unauthorized movement detection subsystem comprising:
means for sensing motion;
a processor responsive to the means for sensing motion for detecting whether motion sensed thereby is indicative of unauthorized movement;
alarm means activated by the processor in response to unauthorized movement; and
power means integrated with the circuit card for powering the unauthorized movement detection subsystem in the event of a lack of available external power including removal of the circuit card.

41. The security system of claim 40 in which the means for sensing motion is an accelerometer.

42. The security system of claim 40 in which the alarm means includes an audible alarm.

43. The security system of claim 40 in which the power means is a rechargeable battery.
